(19) United States
(12) Patent Application Publication
(10) Pub. No.: US 2008/0089272 A1
(43) Pub. Date: Apr. 17, 2008

(54) Connection establishment method

(76) Inventor: Tommi Ahokangas, Pirkkala (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 11/546,389

(22) Filed: Oct. 12, 2006

(51) Int. Cl. H04Q 7/00

(52) U.S. Cl. 370/328; 370/352

(57) ABSTRACT

The present invention relates to a method for connection establishment in a system comprising multiple radio access networks for accessing core network services. A terminal is registered via a first radio access network to an element providing access to circuit-switched core network services. Establishment of a connection via the first radio access network to the element is requested for accessing circuit-switched core network services. As a response to detecting a failure in the establishment of the connection via the first radio access network, attachment to the element via the first radio access network is released and a connection establishment procedure for accessing circuit-switched core network services via a second radio access network is initiated.

### FIELD OF THE INVENTION

The invention relates to connection establishment, and particularly to connection establishment in a system with multiple radio access networks.

### BACKGROUND OF THE INVENTION

Packet-switched data transmission services have been developed for mobile terminals. GPRS services (General Packet Radio Service) are widely used in terminals supporting the GSM radio technology and packet-switched services of the 3GPP system (Third-Generation Partnership Project) based on the WCDMA (Wideband Code Division Multiple Access) radio technology are also based on GPRS.

Besides access via the conventional PLMN (Public Land Mobile Network) access networks, such as the BSS (Base Station Sub-system) of the GSM, there is also a need to enable access to the services of a PLMN by local networks primarily targeted at providing high speed data transmission in a limited area, such as in an office building. WLAN (Wireless Local Area Network) technologies are very popular today and standardization work has been done in the 3GPP to define WLAN-3GPP interworking. This interworking may include the usage of 3GPP subscriber management procedures, such as authentication and charging procedures, as well as data transmission via the 3GPP core network for mobile terminals accessing a WLAN network.

3GPP specification TS 43.318 “Generic access to the A/Gb interface; Stage 2”, version 6.7.0, June 2006, describes an overall architecture for Generic Access (GA) to the A/Gb interfaces, i.e. interfaces from access network to Mobile Switching Center MSC and Serving GPRS Support Node SGSN, respectively. Generic Access to the A/Gb interfaces, or GA, is an extension of GSM/GPRS mobile services that is achieved by tunnelling 3GPP non-access stratum NAS protocols between the MS and the 3GPP core network over an IP network. The IP access network may be a WLAN but could also be some other radio access network. The GA is a complement to traditional GSM/GPRS/UTRAN radio coverage. A generic access network controller (GANC) is an element between the generic IP access network and the A/Gb interface to the 3GPP core network. The GANC appears to the core network as a GERAN Base Station Subsystem BSS.

3GPP specification TS 44.318 “Generic Access (GA) to the A/Gb interface; Mobile GA interface layer 3 specification”, version 7.0.0, July 2006 describes the procedures used over a generic access interface between the GANC and the mobile station MS connected to the IP access network, i.e. the Up interface. This document specifies the handling of a secure connection, Discovery and Registration, CS domain and PS domain signalling and voice and data. All traffic over the Up interface shall be sent through the IPsec tunnel that is established as a result of an authentication procedure.

In order to be able to access PLMN circuit-switched CS domain services via GAN and the GANC, the mobile station has to register in the GANC, and after registration, request establishment of a GA-CSR connection between the MS and the GANC, as defined in Chapter 7 of said TS 44.318 specification. If an error occurs, the mobile station has to indicate an error to the upper layers and remain attached in the GANC. However, the mobile station may be subject to an endless loop when all GA-CSR connection attempts for a mobile originated MO call creation are failing.

### BRIEF DESCRIPTION OF THE INVENTION

The object of the invention is to improve access establishment to an element providing access to circuit-switched core network services for a mobile device connected to a radio access network. The objects of the invention are achieved by a method, an apparatus, a computer program, and a module, which are characterized by what is stated in the independent claims. Some embodiments are disclosed in the dependent claims.

According to an aspect of the invention, a terminal is registered via a first radio access network to an element providing access to circuit-switched core network services. Establishment of a connection via the first radio access network to the element is requested for accessing circuit-switched core network services. As a response to detecting a failure in the establishment of the connection via the first radio access network, attachment to the element via the first radio access network is released and a connection establishment procedure for accessing circuit-switched core network services via a second radio access network is initiated.

In one embodiment, the first radio access network is an IP access network, and the second radio access network is a cellular radio access network.

The terminal may be configured to handle the detected failure as a lower layer fault. Thus, at least one connection or a tunnel used for communicating with the element may be released by a protocol entity below an entity for the connection establishment.

The terminal may in one embodiment enter a deregistered state of a sub-layer handling registration to the element as a response to detecting a failure in the establishment of the connection. Further, the terminal may transmit a deregistration request message to the element.

One advantage is that the service reliability can be improved in case of a problem in connection establishment to an element providing an access to circuit-switched core network service for a terminal via a first radio access network. In an embodiment applying the Generic Access (GA) to the A interface, the endless loop problem caused by an error in the connection set-up (in a GA-CSR layer responsible for connection set-up between the element and the terminal) may be avoided and the GA service exited. In other words, failures other than lower layer protocol failures and which cannot be noticed by lower layer functions, can now be reacted appropriately and the loop may be avoided. For instance, the terminal can then automatically release all resources to the GA system and initiate connection establishment via a GSM BSS/GERAN access network if the connection set-up to the GANC fails. Hence, due to improved service reliability, local access networks could be favoured as first access means to circuit-switched core network services.

### BRIEF DESCRIPTION OF THE FIGURES

In the following, some embodiments of the invention will be described in detail with reference to the accompanying drawings, in which

FIG. 1 generally illustrates a 3GPP system with generic IP access network;

FIG. 2 shows protocol architecture for circuit-switched (CS) control plane in a 3GPP system with generic IP access network;

FIG. 3 is a flow diagram of an embodiment of the present invention;

FIG. 4a and 4b illustrate further embodiments of the present invention;

FIG. 5a illustrates basic elements of a mobile station; and

FIG. 5b illustrates logical mobile station architecture for CS domain control plane.

### DETAILED DESCRIPTION OF EMBODIMENTS

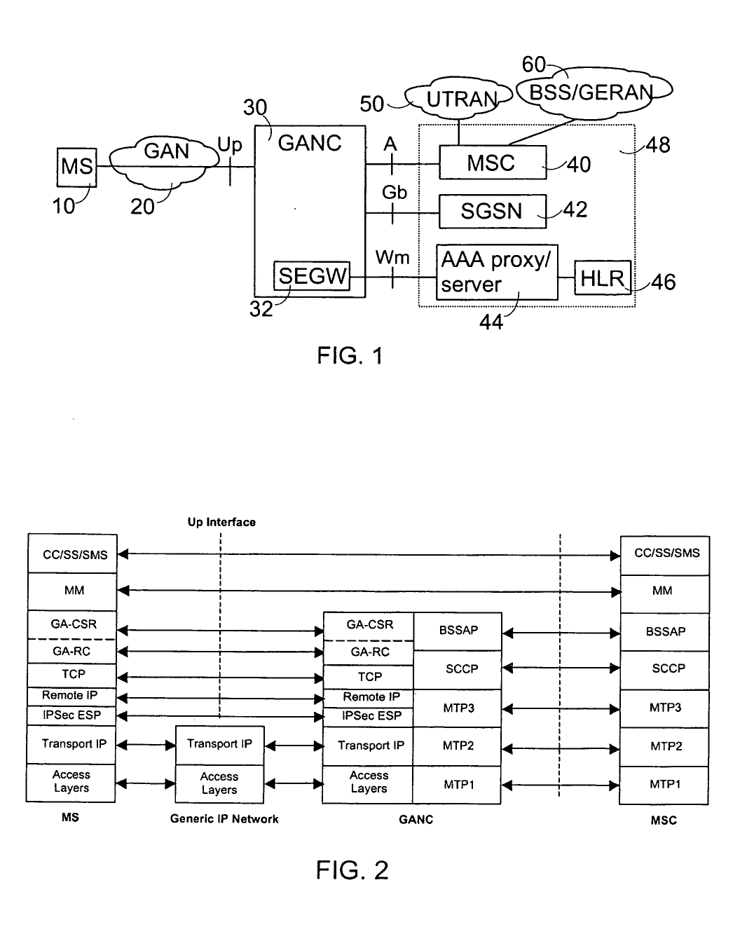

An embodiment is illustrated next with reference to an exemplary 3GPP GAN interworking system illustrated in FIG. 1. However, the present inventive features are applicable to any system in which access to circuit-switched core network services may be arranged via a plurality of radio access networks. The present general method and the apparatus and means to implement the method are applicable in connection with any 2G, 3G, 4G or higher generation mobile communication technology and their different versions. In one embodiment the local access network is any IEEE 802-based wireless local area network. For instance, the local access network may be IEEE 802.11 or 802.16 (or Wimax) based network. However, the present features may be applied in other types of radio access networks via which an access to circuit-switched core network services may be arranged, such as networks operating at unlicensed frequency bands, for instance a network according to the BRAN (Broadband Radio Access Networks) standard, a Home RF network or a Bluetooth network.

Reference is made to FIG. 1, in which the main parts of a mobile system include a generic IP access network GAN 20 and a 3GPP core network part 48 for PLMN circuit-switched CS and packet-switched PS domain services, and a mobile station MS, also called user equipment UE in many 3GPP specifications.

As illustrated in FIG. 1, 3GPP core network services may also be accessed via other radio access networks, such as UMTS terrestrial radio access network UTRAN 50, GSM base station subsystem BSS/GSM/EDGE radio access network GERAN 60, and EUTRAN (3GPP proposal of an evolution of the 3G WCDMA system towards a beyond 3G system). The GSM radio access network 60 includes of base transceiver stations (BTS) and base station controllers (BSC). The UTRAN 50 includes base stations BS, which are called Node Bs, and radio network controllers (RNC).

The mobile station MS may be a mobile phone, a table computer with a WLAN radio interface adapter, or a PDA device, for instance. There may be mobile stations MS of different classes according to their capabilities. The MS may support data transfer via the GAN 20, UTRAN 50, BSS/GERAN 60, and/or some other network, even substantially simultaneously. The mobile station MS is equipped with an IC card including a (U)SIM utilized by a 3GPP subscriber to access the GAN for 3GPP interworking purposes.

The GAN 20 may be any type of local IP based access network. The GAN can operate as a 3GPP access network, and it may be further configured to provide access to other networks, such as the Internet. The GAN comprises access elements, typically called access points AP, which provide a mobile station MS 10 with radio access and thus terminate the radio connection. The GAN 20 may also comprise further network elements, such as a control element and/or a gateway element.

The 3GPP core network 48 comprises an MSC 40 for CS domain services, an SGSN 42 and a gateway GPRS support node GGSN (not shown) for PS domain services. Furthermore, the system comprises an Authentication, Authorization and Accounting (AAA) server 44, which is used to authenticate a mobile station MS 10 accessing the GAN 20. 3GPP network subscriber data and authentication services can thus be used for mobile stations MS roaming in the GAN and comprising a UMTS subscriber identity module USIM and/or a (GSM) SIM. A HLR/HSS 46 (Home Location Register/Home Subscriber Server) located within the 3GPP subscriber's home network is the entity containing the authentication and subscription data required for the 3GPP subscriber to access 3GPP services. It is to be noted that the 3GPP system comprises many further elements/functions not illustrated in FIG. 1 for clarity purposes.

A generic access network controller GANC 30 is an element between the generic IP access network and the A/Gb interface to the 3GPP core network. The GANC 30 appears to the core network as a GERAN Base Station Subsystem BSS. It includes a security gateway SEGW 32 that terminates secure remote access tunnels from the MS, providing mutual authentication, encryption and data integrity for signalling, voice and data traffic. The SEGW 32 supports Wm authentication procedures with the AAA proxy/server 44. The IP transport connection extends from the GANC to the UE. A single interface, the Up interface, is defined between the GANC and the UE. As regards packet-switched services, the GANC 30 provides inter-working data transport channels over Up interface to packet flows over Gb interface. For user plane circuit switched services, the GANC 30 reframes AMR/RTP (Adaptive Multi-rate/Real-Time Protocol) to AMR/(A-interface framing).

FIG. 2 illustrates protocol architecture for circuit-switched (CS) control plane in a 3GPP system with generic IP access network (such as the GAN 20). Access layers and transport IP layer provide the generic connectivity between the MS 10 and the GANC 30. The IPsec layer provides encryption and data integrity. TCP is used to provide reliable transport for GA-RC (Generic Access-Resource Control) between MS and GANC and is transported using the Remote IP layer. The GA-RC manages the IP connection, including the GAN registration procedures. The GA-CSR (Generic Access-Circuit Switched Resources) protocol performs functionality equivalent to the GSM-RR protocol, using the underlying connection managed by the GA-RC. Above protocols, such as mobility management MM, supplementary services SS and short message service SMS, are carried transparently between the MS 10 and MSC 40. The GANC 30 terminates the GA-CSR protocol and inter-works it to the A-interface using BSSAP (base station system application part) messaging. The Remote IP layer is the ‘inner’ IP layer for IPsec tunnel mode and is used by the MS to be addressed by the GANC. Remote IP layer is configured during the IPsec connection establishment.

For a more detailed description of the generic access to the A/Gb interface, reference is made to the 3GPP specification TS 43.318 “Generic access to the A/Gb interface; Stage 2”, version 6.7.0, June 2006. It is to be noted that the GAN-3GPP interworking specification work is not finished at the time of filing of the present application, and the basic principles of the solution being described can be applied in modified GAN-3GPP interworking systems.

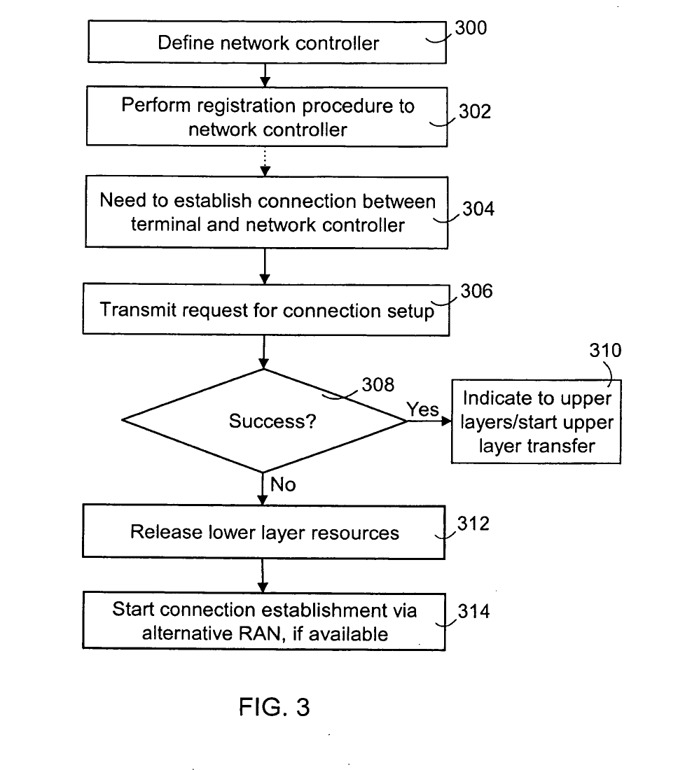

To obtain services via the GAN 20, the mobile station 10 has to perform a GAN technology-specific access procedure, for instance by applying some IEEE 802.1x based access procedure. FIG. 3 illustrates further access establishment procedure according to an embodiment.

In order to be able to access mobile-originated (MO) PLMN circuit-switched CS domain services via the GAN 20 and the GANC 30, the mobile station 10 has to select a GANC 30 and register to the selected GANC. In step 300 the MS 10 defines a network element or controller providing access to circuit-switched services, in the present embodiment a GANC to which the MS 10 shall attach. This step may involve at least some of the discovery procedures illustrated in Chapter 5 of the 3GPP specification TS 44.318 “Generic Access (GA) to the A/Gb interface; Mobile GA interface layer 3 specification”, version 7.0.0, July 2006. It is to be noted that if the MS 10 is initially aware of a default GANC, which is also available, the MS does not have to perform Discovery procedure, but may simply select the predetermined default GANC as the target for registration.

For all communications over the Up interface, the MS 10 and the GANC 30 first establish an IPsec tunnel as a result of an authentication procedure (not shown as a specific step). The applicability of the functions illustrated above is not limited to any specific underlying transport technology. For instance, various tunneling techniques may be applied in the 3GPP-GAN embodiment. In one embodiment, tunnels are IPSec tunnels and identified by at least one IPSec tunnel specific identifier, which may be used when binding authorization (and the classification parameters thereof) to the tunnel and when arranging underlying data transmission resources. The IPSec tunnel may be established between the MS 10 and the GANC-SEGW 32 by utilizing the IKE (Internet Key Exchange) protocol. First, a key exchange is performed by Diffie-Hellman procedure and an IKE security association is generated. In one embodiment, the IKE security association is authenticated by using an EAP (Extensible Authentication Protocol) SIM or EAP AKA (Authentication and Key Agreement) procedure. After this, separate security associations are negotiated for user traffic.

In step 302 the MS 10 performs a registration procedure with the defined GANC 30. This step may involve transmission of GA-RC REGISTER REQUEST/ACCEPT messages. More information on the registration procedure is available in Chapter 6 of the above mentioned 3GPP specification TS 44.318. After registration, the GA-RC sub-layer in the MS 10 is in GA-RC-REGISTERED state.

The MS 10 may assume different operating states or modes for GAN access purposes, namely an idle mode and a dedicated mode. The basic difference between these modes is that in the idle mode, the MS has no connection or communication context established to the radio access network, but in the dedicated mode, a transport channel or a connection has been established between the MS and the GANC 30. More specifically, the GA-CSR sub-layer in the MS 10 can be in two states: GA-CSR-IDLE or GA-CSR-DEDICATED. The MS 10 moves from the GA-CSR-IDLE state to the GA-CSR-DEDICATED state when the GA-CSR connection is established and returns to GA-CSR-IDLE state when the GA-CSR connection is released.

In step 304 there is a need to establish a bearer or connection between the MS 10 and the GANC 30 to enable access for the MS 10 to the PLMN circuit-switched CS domain services. In other words, besides an underlying logical signaling connection (in the GAN-3GPP embodiment the secure tunnel), a further connection, in the GAN-3GPP embodiment a GA-CSR layer connection needs to be established. It is to be noted that there may be many triggers for step 304. In the present mobile-originated call establishment embodiment a user input has selected a call establishment (in connection with step 304 or already earlier before step 300).

The registered MS 10 is arranged to request establishment of a GA-CSR connection. The GA-CSR connection is a logical connection between the MS and the GANC for the CS domain and enabling transmission of NAS messages to the network. It is established when an upper layer in the MS 10 requests GA-CSR (in step 304) to enter dedicated mode.

The MS 10 prepares, and transmits to the GANC 30, a request for connection establishment 306, which in the 3GPP-GAN embodiment may be a GA-CSR REQUEST message.

In step 308 the MS 10 detects if the GA-CSR layer connection set-up has been successful or not. If, on the basis of a check in step 308, the connection set-up has been successful, i.e. a GA-RC REGISTER ACCEPT has been received, in step 310 the MS 10 may start to transfer data by utilizing the connection to the GANC 30; there may be some further procedures preceding user information transfer. The MS 10 thus enter a dedicated state, in the 3GPP-GAN embodiment the GA-CSR-DEDICATED state, indicate success to upper layers. Then the MS 10 may start transfer of upper layer messages, such as Call Control CC L3 messages to the MSC 40. In the present embodiment the MS may then transmit GA-CSR UPLINK DIRECT TRANSFER messages to the GANC 30 for the transfer of upper layer messages and receive GA-CSR DOWNLINK DIRECT TRANSFER messages.

If, on the basis of a check in step 308, the connection set-up has been unsuccessful, the MS 10 is arranged to release 312 lower layer resources for GAN access. Particularly, this step is entered as a response to a GA-CSR layer failure and if no response to the GA-CSR REQUEST message is received (within a time limit). This may happen if the GANC 30 server is not functioning properly or there is a problem in the generic IP access network. In a further embodiment step 312 is entered as a response to expiry of the timer TU3908. This step may involve release of all or only some lower layer resources between the MS 10 and the GAN 20 and/or GANC 30. In other words, the MS may be arranged to detach from the IP access network GAN 20 and the GANC 30. The release of lower layer resources refers generally to at least releasing attachment to the GANC 30 or similar element providing access to PLMN core network resources via the IP access network.

In one embodiment the communications apparatus is in step 312 configured to perform a rove out procedure from the GAN to a cellular radio access network 50, 60 in order to access the desired CS service. Thus, the MS 10 detaches from the GAN 20 and the GANC 30.

In one embodiment the MS 10 is in step 312 arranged to treat the detected (upper GA-CSR layer) fault as a lower layer fault and perform at least one of the following: release the TCP connection towards the current GANC 30, if established, release the secure connection towards SEGW 32 of the current GANC 30, if established, start a timer, such as the TU3905, and enter the GA-RC-DEREGISTERED state. It is to be noted that the MS 10 may not be able to deregister first with the GANC 30, in which case the MS 10 merely detaches from the generic IP access network. It is further to be noted that the procedures in current Chapter 9.5 of said 3GPP 44.318 are only applied in case of lower layer faults, such as missing TCP acknowledgement, and the only error handling related to actual connection set-up (in the GA-CSR layer) is defined in Chapter 7.1.4.1 (it is possible that there are no errors detected in lower layers, but the upper layer connection establishment request still fails). Hence, by applying the present features, (the upper layer) signalling connection error handling may be significantly improved, and the loop problem caused by an error avoided, thus enabling an enhanced user service.

In step 314 the MS 10 starts connection establishment procedure via another appropriate radio access network, if available. Some further embodiment or embodiments differing from procedure of FIG. 3 are illustrated below.

A connection establishment procedure may be initiated via a cellular radio access network or another local radio access network. In the present 3GPP-GAN embodiment a connection establishment procedure may be initiated via the BSS 60, GERAN 60, UTRAN 50, or EUTRAN. This step may involve registration to such network. The MS 10 may already be camped on a 2G/3G cell, in which case the MS may initiate connection establishment procedure to the MSC 40 via the camped cell and the respective access network. In one embodiment the MS roves out of the GAN mode to GERAN/UTRAN mode in steps 312 and 314. The MS may be also arranged in step 312/314 to provide further functions not discussed in detail herein, such as indicating to the upper layers the failure to enter GA-CSR to Dedicated state.

In one embodiment, a timer is started in connection with transferring 306 a request for the establishment of the connection. The release of lower layer resources is then initiated if no response is received from the GANC 30 before expiry of the timer. In a further embodiment one or more retransmissions are applied before entering step 312. An example of an applicable timer is the TU3908 specified in said 3GPP 44.318. is to be noted that other timers may be applied, or one timer may be applied for initial request and another timer may be applied in a request retransmission. It is to be noted that the present features are not tied to any specific duration or timer value, and it is possible to use a different durations.

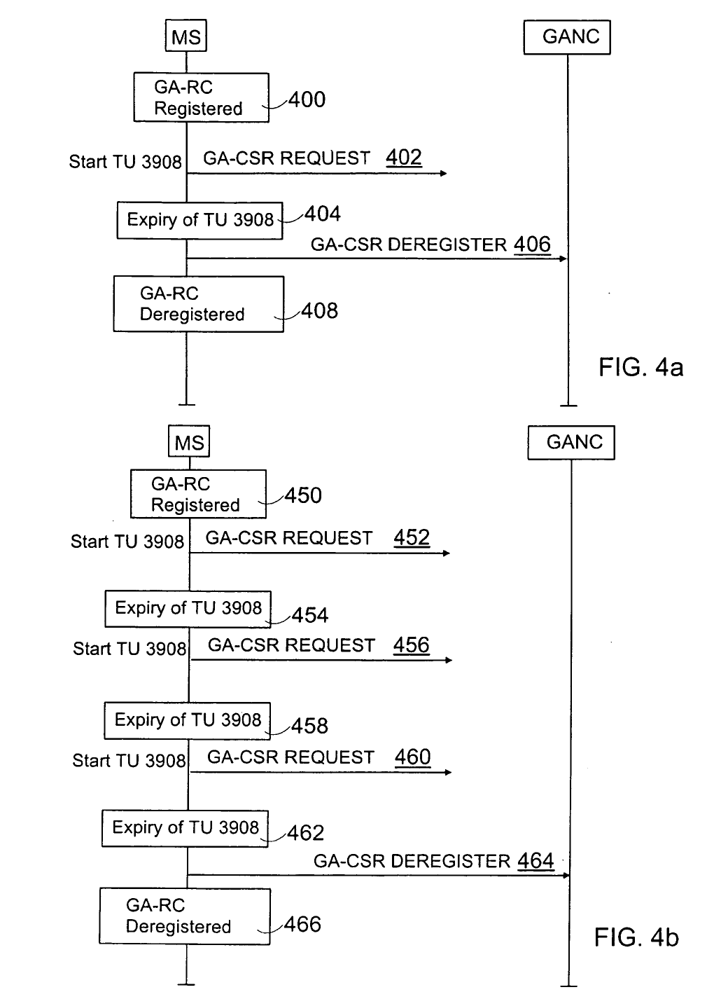

FIGS. 4a and 4b are exemplary signalling diagrams illustrating an access establishment procedure. In the example of FIG. 4a, the registered MS 10, i.e. having already entered 400 the GA-RC Registered state, transmits 402 a GA-CSR REQUEST and starts a timer. If no response is received from the GANC 30 before expiry of the timer, the MS performs a deregistration by transmitting a GA-CSR DEREGISTER message towards the GANC 30, and performs release of lower layer resources as well, which may include also detachment from the GAN 20. After deregistration the MS is in the GA-RC Deregistered mode and may initiate connection establishment via a PLMN cellular access network. The advantage of this embodiment is the fast change to an alternative radio access.

FIG. 4b illustrates an embodiment in which a request for the establishment of the connection is retransmitted and the time re-started 456 if no response is received from the GANC 30 before expiry of the timer 454 for first GA-CSR request 452. If again no response is received from the GANC 30 before expiry 458 of the restarted timer, a second retransmission is carried out 460. the deregistration is initiated or the request for the establishment of the connection is again retransmitted and the time again re-started. If no response is received from the GANC 30 before expiry 462 of the timer, the MS acts 464, 466 as illustrated above in connection with features 406 and 408. By this embodiment, it is possible to have access via GAN despite short-term disruptions in the GAN access.

It is to be noted that FIG. 3, FIGS. 4a and 4b illustrate only some possible implementation options, and there are many other implementation options available. For instance, the number of retransmissions may be varied; the number of retransmissions could be one, three, four or five, for instance. Further, there could be supplementary steps, such as a checking step or a user prompt for confirmation.

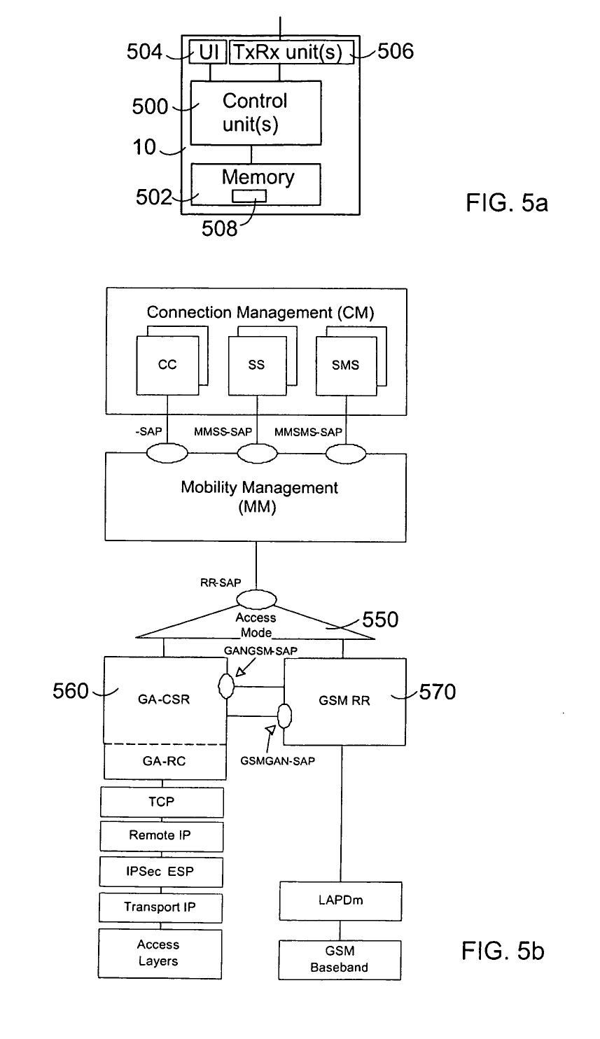

As illustrated in FIG. 5a, a mobile station in general, and the mobile bile station 10 of FIG. 1, comprises one or more units 506 for radio frequency (RF) communications (transmitter, receiver, transceiver) enabling the communication in accordance with the radio access technology or technologies supported by the MS. The MS 10 also includes a user interface 504 for user input/output. The operation of the MS 10 and various elements thereof is controlled by one or more control units 500 (such as a micro controller, microprocessor, or any other programmable device) having an associated memory 502 for storing data and software.

Computer program code portions 508 stored in the memory 502 and executed in the processing unit 500 may be used for causing the device MS 10 to implement a method and means for providing the inventive functions relating to arranging connection establishment in an environment with multiple radio access technologies, some embodiments of the inventive functions were illustrated above in association with FIGS. 2, 3, 4a and 4b. Hardware solutions or a combination of software and hardware solutions may also be used. Above illustrated functions by the MS 10, implemented by the controlled cooperation between the units of FIG. 5a, can also be considered to for logical (sub-)units that implement the radio access connection establishment related features illustrated in FIG. 3, for instance. A chip unit or some other kind of hardware module for controlling the device MS 10 may, in one embodiment, cause the device to perform the inventive functions. The hardware module comprises an interface for connecting to the device MS mechanically and/or functionally. Thus, the hardware module may form part of the device and could be removable. One example of such hardware module is a sub-assembly.

FIG. 5b illustrates a logical architecture for CS domain control plane in the MS 10 according to an embodiment. A control entity, for instance an access controller, may be provided in the MS 10 controlling access establishment with the GANC 30. This control entity may be provided by a GA-CSR control entity 560. The mobile stations 30 may also comprise an access mode controller or switch 550 to switch between radio access networks, such as between GERAN/UTRAN and GAN modes. As illustrated in FIG. 5b, the RR-SAP interface to the GSM-MM layer is preserved identically for both GSM and GAN access. The GA-CSR entity 560 peers with the GSM-RR entity 570 to provide coordination for roving and handover. After detecting an error in the connection set-up with the GANC 30, the GA-CSR entity 560 may initiate release of lower layer resources (by communicating with lower layer entity(-ies)) and interact with switch 550 and/or GSM radio resource RR control entity 560 to initiate connection establishment by utilizing the GSM RR. In steps 312 and 314 the MS 10, or the switch 550 may be arranged to detach GA-CSR from the RR-SAP and (re-) attach GERAN-RR, GSM RR or UTRAN RRC to RR-SAP, and restore normal GERAN-RR, GSM RR or UTRAN RRC functionality. Hence, by the interaction of logical entities in the MS 10 it is possible to implement above illustrated features. These entities may be implemented by execution of a stored program code 508 in a processing unit 500 in the MS 10, for instance.

It is obvious to a person skilled in the art that as technology advances, the basic idea of the invention can be implemented in a variety of ways. The invention and its embodiments are thus not limited to the above examples, but may vary within the claims. Different features may thus be omitted, modified or replaced by equivalents.

1. A method comprising:
registering a terminal via a first radio access network to an element providing access to core network to provide circuit-switched services to the terminal via the first radio access network,
requesting establishment of a connection via the first radio access network to the element for providing circuit-switched core network services for the terminal via the first radio access network,
as a response to detecting a failure in the establishment of the connection via the first radio access network, releasing attachment to the element via the first radio access network, and
initiating a connection establishment procedure for accessing circuit-switched core network services via a second radio access network.

2. A method according to claim 1, wherein the first radio access network is an IP access network.

3. A method according to claim 1, wherein the second radio access network is a cellular radio access network.

4. A method according to claim 3, wherein the second radio access network is one of the following: a universal mobile telecommunications UMTS terrestrial radio access network UTRAN, a GSM base station subsystem BSS, GSM/EDGE radio access network GERAN, and an enhanced UTRAN EUTRAN.

5. A method according to claim 1, wherein the element is configured to provide the connection for the terminal to access public land mobile network PLMN circuit-switched core network control plane services via the first radio access network.

6. A method according to claim 5, wherein the terminal is configured to transmit and receive mobility management signalling messages to and from a mobile-switching center over the connection provided by the element.

7. A method according to any preceding claim 1, wherein a timer is started in connection with transferring a request for the establishment of the connection, and
the attachment is released if no response is received from the element before expiry of the timer.

8. A method according to claim 1, wherein a timer is started in connection with transferring a request for the establishment of the connection,
if no response is received from the element before expiry of the timer, the request for the establishment of the connection is retransmitted and the timer re-started, and
if no response is received from the element before expiry of the restarted timer, the attachment is released or the request for the establishment of the connection is again retransmitted and the timer again re-started.

9. A method according to claim 1, wherein the terminal is configured to enter a deregistered state of a sub-layer handling registration to the element and transmit a deregistration request message to the element as a response to detecting a failure in the establishment of the connection.

10. A method according to claim 1, wherein the detected failure of the connection establishment is handled as a lower layer fault and at least one connection or a tunnel used for communicating with the element is released by a protocol entity below an entity for the connection establishment.

11. A communications apparatus comprising memory for storing program code controlling at least partially operations in the communications apparatus, said program code comprising:
program code configuring the communications apparatus to register via a first radio access network to an element providing access to core network to provide circuit-switched services to the terminal via the first radio access network,
program code configuring the communications apparatus to request establishment of a connection via the first radio access network to the element,
program code configuring the communications apparatus to, as a response to detecting a failure in the establishment of the connection via the first radio access network, release resources related to attachment to the element via the first radio access network, and
program code configuring the communications apparatus to initiate a connection establishment procedure via a second radio access network.

12. A communications apparatus according to claim 11, wherein the first radio access network is an IP access network, and the second radio access network is a cellular radio access network.

13. A communications apparatus according to claim 12, wherein the second radio access network is one of the following: a universal mobile telecommunications UMTS terrestrial radio access network UTRAN, a GSM base station subsystem BSS, GSM/EDGE radio access network GERAN, and an enhanced UTRAN EUTRAN.

14. A communications apparatus according to claim 13, wherein the first radio access network is a generic IP access network GAN of a 3GPP generic access system and the communications apparatus is configured to communicate with generic access network controller GANC of the 3GPP generic access system, and
the communications apparatus is configured to perform a rove out procedure from the GAN.

15. A communications apparatus according to claim 14, wherein the communications apparatus is configured to use the connection with the element to access public land mobile network PLMN circuit-switched core network control plane services via the first radio access network, whereby
the communications apparatus is configured to transmit and receive mobility management signalling messages to and from a mobile-switching center over the connection provided by the element.

16. A communications apparatus according to claim 11, wherein the communications apparatus is configured to start a timer in connection with transferring a request for the establishment of the connection, and
the communications apparatus is configured to release the attachment if no response is received from the element before expiry of the timer.

17. A communications apparatus according to claim 11, wherein the communications apparatus is configured to start a timer in connection with transferring a request for the establishment of the connection,
if no response is received from the element before expiry of the timer, the communications apparatus is configured to retransmit the request for the establishment of the connection and re-start the timer, and
if no response is received from the element before expiry of the restarted timer, the communications apparatus is configured to release the attachment or the communications apparatus is configured to retransmit the request for the establishment of the connection and re-start the timer.

18. A communications apparatus according to claim 11, wherein the communications apparatus is configured to change a state of a sub-layer handling registration to the element as deregistered and transmit a deregistration request message to the element as a response to detecting a failure in the establishment of the connection.

19. A communications apparatus according to claim 11, wherein the communications apparatus is configured to handle the detected failure in the connection establishment as a lower layer fault, and
a protocol entity below an entity for the connection establishment in the communications apparatus is configured to release a connection or a tunnel used for communicating with the element.

20. A communications apparatus comprising a control unit, wherein
the communications apparatus is configured to transmit a generic access circuit switched resources sub-layer connection request to a generic access network controller via an Internet protocol IP access network, and
the communications apparatus is configured to, as a response to detecting, on the basis of an expiry of a timer started in connection with the transmission of the request, a failure in the establishment of the connection via the IP access network for circuit-switched communications with the public land mobile network, treat the failure as a lower layer failure and perform at least one of the following features: release a transport control protocol TCP connection towards the generic access network controller, release the secure connection towards the generic access network controller, start a timer, and enter generic access resource control deregistered state.

21. A module comprising an interface for connecting to a communications device, wherein the module is configured to:
request establishment of a connection via a first radio access network to an element providing access to core network to provide circuit-switched services to the terminal via the first radio access network,
as a response to detecting a failure in the establishment of the connection via the first radio access network, release attachment to the element via the first radio access network, and
initiate a connection establishment procedure for accessing circuit-switched core network services via a second radio access network.

22. A module according to claim 21, wherein the module is a sub-assembly for a mobile station.

23. A computer readable medium storing a computer program product for a communications device, comprising:
code for requesting establishment of a connection via a first radio access network to an element providing access to core network to provide circuit-switched services to the terminal via the first radio access network,
code for releasing attachment to the element via the first radio access network as a response to detecting a failure in the establishment of the connection via the first radio access network, and
code for initiating a connection establishment procedure for accessing circuit-switched core network services via a second radio access network.

24. A computer readable medium as claimed in claim 23, comprising code for entering a deregistered state of a sub-layer handling registration to the element and transmit a deregistration request message to the element as a response to detecting a failure in the establishment of the connection.

25. A computer readable medium as claimed in claim 23, comprising code for handling the detected failure of the connection establishment as a lower layer fault and controlling release of at least one connection or a tunnel used for communicating with the element.
